(19) United States
(12) Patent Application Publication
(10) Pub. No.: US 2015/0356548 A1
(43) Pub. Date: Dec. 10, 2015

(54) SYSTEMS AND METHODS FOR PROVIDING A GRATUITY

(71) Applicant: BRAVO, LLC, Scottsdale, AZ (US)

(72) Inventors: Hector Luna-Rodriguez, Scottsdale, AZ (US); Maria Luna-Luciano, Scottsdale, AZ (US)

(21) Appl. No.: 14/730,764

(22) Filed: Jun. 4, 2015

Related U.S. Application Data
(60) Provisional application No. 62/009,765, filed on Jun. 9, 2014.
(60) Provisional application No. 62/111,888, filed on Feb. 4, 2015.
(60) Provisional application No. 62/117,631, filed on Feb. 18, 2015.

(51) Int. Cl. G06Q 20/32; H04W 4/02

(52) U.S. Cl. CPC G06Q 20/3224; H04W 4/02

(57) ABSTRACT

In accordance with one embodiment, a method includes deriving a location of a consumer based, at least in part, on a datum associated with a mobile device, accessing one or more accounts of a plurality of service providers to identify one or more service providers having a registered location that is within a predetermined proximity to the derived location, transmitting displayable data that is associated with the plurality of identified service providers to the mobile device, receiving an indication of a chosen service provider selected from the displayed plurality of identified service providers, receiving a money transfer request from the mobile device, wherein the request is to transfer funds from an account that is associated with the mobile device to a second account that is associated with chosen service provider and transferring the funds into the second account.

### CROSS REFERENCE TO RELATED APPLICATIONS

This application claims priority to the following provisional U.S. patent applications, which are hereby incorporated by reference in their entirety: provisional U.S. patent application 62/009,765 filed Jun. 9, 2014, provisional U.S. patent application 62/111,888 filed Feb. 4, 2015 and provisional U.S. patent application 62/117,631 filed Feb. 18, 2015.

### BACKGROUND

There are many occupations that rely on tips (sometimes referred to as gratuities) as part of their income. For example, waitresses and waiters, bellhops, maids, valets, and cab drivers all gain part of their income from tips. Sometimes a consumer does not have the appropriate funds available to tip such a service provider. Moreover, a consumer sometimes does not know the appropriate amount to tip such a service provider, the tipping custom for a particular occupation, or the tipping custom for a part of the world. As a result, the service provider can be under tipped, over tipped, or not tipped at all. Such a situation is unsatisfactory for both the person who provided the service and wants to be tipped appropriately and the person who received the service and wants to tip appropriately.

### SUMMARY

In accordance with an exemplary and non-limiting embodiment, a method comprises deriving a location of a consumer based, at least in part, on a datum associated with a mobile device, accessing one or more accounts of a plurality of service providers to identify one or more service providers having a registered location that is within a predetermined proximity to the derived location, transmitting displayable data that is associated with the plurality of identified service providers to the mobile device, receiving an indication of a chosen service provider selected from the displayed plurality of identified service providers, receiving a money transfer request from the mobile device, wherein the request is to transfer funds from an account that is associated with the mobile device to a second account that is associated with chosen service provider and transferring the funds into the second account. In embodiments, the datum associated with a mobile device may be a GPS datum, derived via cell phone triangulation, derived from location information that is associated with a detected wi-fi network (e.g., an IP address), or some other type of datum associated with a mobile device conveying location information. In embodiments, a registered location may be static or dynamic, and may be updated periodically by a service provider or some other entity. In embodiments, the displayed plurality of service providers may be filtered by occupation.

In accordance with an exemplary and non-limiting embodiment, a method comprises deriving a location of a consumer based, at least in part, on a datum associated with a mobile device, accessing one or more accounts of a plurality of service providers to identify one or more service providers having a registered location that is within a predetermined proximity to the derived location, transmitting displayable data that is associated with the plurality of identified service providers to the mobile device, receiving an indication of a chosen service provider selected from the displayed plurality of identified service providers, receiving a money transfer request and a text-based message from the mobile device, wherein the request is to transfer funds from an account that is associated with the mobile device to a second account that is associated with chosen service provider and the text-based message is intended for the chosen service provider, transferring the funds into the second account and transmitting a communication to a second mobile device that is associated with the chosen service provider, wherein the communication includes at least a confirmation of the funds transfer and the text-based message. In embodiments, the registered location may be static or dynamic. In embodiments, the displayed plurality of service providers may be filtered by industry or some other datum that is associated with the service providers. In embodiments, feedback may be associated with a service provided by a chosen service provider in proximity to a registered location of a chosen service provider.

In accordance with an exemplary and non-limiting embodiment, a method comprises deriving a location of a consumer based, at least in part, on location information associated with a detected wi-fi network, accessing one or more accounts of a plurality of service providers to identify one or more service providers having a registered location that is within a predetermined proximity to the derived location, transmitting displayable data that is associated with the plurality of identified service providers to the mobile device, receiving an indication of a chosen service provider selected from the displayed plurality of identified service providers, receiving a money transfer request from the mobile device, wherein the request is to transfer funds from an account that is associated with the mobile device to a second account that is associated with chosen service provider and transferring the funds into the second account. In embodiments, the registered location may be static or dynamic. In embodiments, a registered location may be updated periodically by a service provider and displayable data may be filtered by occupation or some other datum that is associated with a service provider.

These and other systems, methods, objects, features, and advantages of the present invention will be apparent to those skilled in the art from the following detailed description of the preferred embodiment and the drawings.

### BRIEF DESCRIPTION OF THE DRAWINGS

A further understanding of the nature and advantages of the present technology may be realized by reference to the figures, which are described in the remaining portion of the specification.

FIG. 1 illustrates an example of a network that can be used to provide a remote tipping system in accordance with one embodiment.

FIG. 2 illustrates a block diagram of a computing system that can be used to implement computing devices described herein, in accordance with one exemplary embodiment.

FIG. 3 illustrates an example of an email with tip pool information that a participant may receive at the end of each shift in accordance with one exemplary embodiment.

FIG. 4 illustrates a simplified diagram of a system that may be used to allocate tips across a plurality of tippees in accordance with one exemplary embodiment.

FIG. 5 illustrates a simplified diagram of a system that may be used to enable a manager to split or allocate tips to a plurality of tippees in accordance with one exemplary embodiment.

FIG. 6 illustrates a simplified diagram of a system that may be used to allocate multiple gratuities in accordance with one exemplary embodiment.

FIG. 7 illustrates a simplified diagram of a system that may be used to process a gratuity in accordance with one exemplary embodiment.

FIG. 8 is an illustration of an exemplary and non-limiting embodiment of a method for adding a new account via a tipping application.

FIG. 9 is an illustration of an exemplary screen of a smartphone from which a user may select a tip array.

FIG. 10 is an illustration of a method in accordance with an exemplary and non-limiting embodiment.

FIG. 11 is an illustration of a method in accordance with an exemplary and non-limiting embodiment.

FIG. 12 is an illustration of a method in accordance with an exemplary and non-limiting embodiment.

### DETAILED DESCRIPTION

In accordance with the technology described herein, a consumer may now provide a tip to a service provider independent of the normal custom of handing a service provider cash or adding a tip to a bill. The new technology may even be used from a remote location and at a remote time from where and when a service was provided. This can be useful in many situations. For example, it is not uncommon for a consumer to not have cash immediately available, or only have small bills or large bills on his or her person that can be used to tip a service provider, such as a valet, bell boy, concierge, etc. Moreover, it is not uncommon for a consumer to be unsure how much they should tip a particular type of service provider. So, out of confusion, that service provider is often under tipped, over tipped, or not tipped at all. Similarly, a consumer often desires to provide more feedback than just a tip. A message of appreciation or criticism is something that a consumer will often want to convey to a waiter/waitress/service person or his/her associated management. In accordance with different embodiments described herein, these features can now be implemented.

In accordance with one embodiment of the technology described herein, a consumer may download a software application to his or her computing device, such as his or her mobile phone. The application can be implemented by the user's mobile phone, smart phone, tablet, etc using the processor and memory of the mobile phone.

A computer server can be provided that allows both consumers (e.g., tippers) and service providers (e.g., tippees) to register as users of the system. A tipper first creates an account on the system (smart device or personal computer) so that the system can identify that particular user. In one embodiment, the user's mobile device can be tracked by the system so that the system knows from the user's global positioning system (GPS) coordinates where the consumer is located. While described with reference to the use of GPS to determine a location of an entity, such as a consumer or service provider, the present disclosure is drawn broadly to incorporate all means of determining an approximate location of any such entity. For example, cell tower triangulation and associating predetermined location information with a wi-fi network (e.g., using IP address) are but two additional examples of methodologies that may be employed to determine the location of an entity. In general, methodologies for determining a location of a consumer may include network-based and handset-based technologies, SIM-based, Wi-fi and hybrid systems. In accordance with various exemplary and non-limiting embodiments, data transmission protocols that may be employed as part of the platform may include, but are not limited to Long-term Evolution (LTE), 3G, 4G, 5G and successive generations of mobile telecommunications technology. The service provider may also be identified by a system identifer (ID), QR code, near field communication (NFC), blue tooth, beacon technology or Android Beam.

In one embodiment, the global positioning system will work separated and/or along with the near field communication to identify the service provider most effectively. For example, if the GPS system experiences poor signal reception, the NFC system still will be able to identify the service provider. In this regard, beacon and Android beam can also serve this purpose.

The tippee can configure during the account set-up of the mobile device (e.g., by use of smart device or personal computer) so that a suggested pre-defined tip amounts can be selected when the tipper (consumer) opts to tip a service provider. For example, the mobile device can be configured to allow the consumer to choose between $5, $10, $15 or “other” option in the display of the consumer's phone when the consumer chooses to leave a tip for a service provider. In addition, the mobile device can be configured to allow the consumer to enter (“other”) and leave a specific tip amount. This could be implemented by first showing a screen to the user that allows the user to select “Leave a specific tip amount.” Then a dialog box could be displayed that allows the user to enter a specific amount. In other embodiments, tip amounts may be configured to reflect percentages of the price of goods or services. For example, a consumer may be provided with the option of choosing between 15%, 18%, 20% and 25% of the price of a good or service.

The tippee can also choose to split or share the gratuity generated for the service (the shift, per a single customer, the night, the week, etc) with coworkers by percentage or specific amount. There is a set up option that allows sharing the gratuity amongst members of the team. For example, upon turning on the sharing feature, a screen will ask to pick the coworkers who will receive a percentage share or specific amount. The tipee may choose the coworker(s) to receive the shared gratuity and select the percentage which will be taken for the tip; that amount will be automatically transferred to that coworker(s) account.

Alternatively, for consumers who dine out frequently the mobile device could be preconfigured to allow the consumer to select from a range of percentages. For example, the consumer could be presented with the option to choose from 10%, 15%, or 20% of the total cost of the meal (not including tax).

In accordance with another embodiment, the user could configure a computing device to tip different percentages based on the type of food. For example, if a user likes to tip 10% for drinks and 15% for food, a screen could be displayed that allows the consumer to enter the cost for the drinks, enter the cost for the food, and compute the total tip due. This allows the consumer to tip according to the consumer's preference.

In accordance with one embodiment, a consumer can use the application to easily identify service providers who are registered with the system or have an identification code. As will be explained below, a tippee can register with the system and obtain a unique ID code, Branded Code or QR code that can be used to identify the particular service provider. When the tippee is registered with the system, the tippee will enter a geographical location and/or business name where the tippee is located. GPS and NFC technology will be activated or not by tippee by preference. QR code and Branded Code (ID) will be a permanent “on feature” for recognition any time or when in locations with poor satellite or no wifi availability or by tipper or tippee's preference. Therefore, when a consumer wants to identify the particular service provider for whom a tip should be attributed to, the consumer can search by geographical location and even provide a tip from a remote location and remote time (if the tipper wishes). The account will remember the tippee and will give the ability to reach back for positive reinforcement and remote tipping. This is possible only if allowed by the tippee (under permissions). This can be done by accessing the server and supplying GPS coordinates from the present location of the consumer's phone, for example. As another example, it could be done by entering the name of the business (e.g., the name and address of a restaurant). Otherwise, tippee could always be identified by other non satellite non-cellular network technologies (NFC, QR code, Branded code, picture).

Once the server has the geographical location information that corresponds to where the service was provided, the server can send profiles of service providers in that area to the consumer's computing device. These profiles can be filtered by the service they offer. For example, they can be filtered to just show waitresses rather than waiters, valets, concierges, and maids for a hotel, for example. When the profiles are displayed on a consumer's mobile device, the consumer can select the service provider that provided the service to him/her. The service provider can be identified by name and picture. Then, the consumer can select the appropriate amount of tip to be accorded to that service provider.

This is very helpful to a consumer who does not have appropriate funds to tip a service provider when the service provider is in the process of providing a service. Instead, the consumer can simply let the service provider know that the consumer uses the tipping app. Then, at a remote time and/or location, the consumer can identify the service provider's profile and apply the appropriate tip. For example, this is very helpful to a valet who often does not get tips because the consumers do not have small bills on them when the valet returns their car. Using the present system, a consumer can look up the particular valet in the geographic area, select his/her profile, and apply a tip. The service provider can have an ID tag (e.g., a Branded Tag) and/or a QR code. The service provider could also be identified by near field communication technology (NFC), beacon, Android beam, bluetooth or the like.

In accordance with another embodiment, a consumer may also provide feedback about a service that was received. This feedback can be utilized in a variety of ways. For example, the feedback can go to a particular service provider. Or, the feedback could go to the management who employs the service provider. Also, the feedback could go to the system operator of the tipping/feedback system so that the feedback can be used for different purposes.

As noted, one manner of providing feedback is to provide a screen at the time of tipping (or at some other time) that allows the consumer to enter a short message. This message can be uploaded to the server and directed by the server to the service provider. One type of message that would be anticipated would be that the service provider provided excellent service. Another type of message that might be anticipated would be constructive criticism—e.g., “the reason I only tipped you 10% is because it took you ten minutes to bring me my bill after you cleared my plates.” Even such constructive criticism can provide the service provider with value in how the service provider might choose to improve the service that is given. In some instances, a user might even be so upset with the service that the user does not leave a tip, but does want to provide constructive criticism to the service provider. In that instance, a message could be all that is conveyed.

In one embodiment, the consumer may also want to let the management associated with the service provider know about the quality of service. In that situation, the message can be forwarded to the manager that is associated with a particular service provider. In such a situation, it is envisioned that the tippee would register as being associated with a particular business or a particular manager. Thus, when the consumer elects to include the manager in the communication, the system has contact information for that manager.

In another embodiment, the consumer may want to communicate with the management and not the service provider. For example, if a service provider is suboptimal or particularly bad, e.g., a particularly bad waiter, the consumer may want to send a message to the management associated with that waiter and request a replacement waiter.

In some instances, the consumer will not even know who their service provider is. For example, after being seated in a busy restaurant, a consumer might feel that they have been forgotten while waiting to have their order taken. In such a situation, the consumer can send a message directly to the management associated with the business. For example, a message such as: “We've been seated for twenty minutes and nobody has come to take our order” could be sent to a QR code for management located at the table.

In addition to providing a comment to or about the service provider, a consumer may also provide a rating of a service provider. For example, after a consumer selects an appropriate amount to tip a service provider, the system can cause a screen to appear on the consumer's mobile device that asks the consumer to rate the service provider on a scale such as 1-10. This rating can be conveyed to the appropriate party, such as the system operator or the manager of the service provider. As will be explained further such ratings can be useful to service providers, consumers, and businesses.

In accordance with one embodiment, the system can also be used to provide communications between consumers and service providers. For example, if a business owner frequently entertains clients at a local restaurant, the business owner will likely have frequent interaction with the maître'd at that restaurant. Using the technology provided by the system described herein, the consumer can access the profile for the maître'd and send a message to the effect of “I would like to reserve a table for 5 at 6 PM.” The maître'd can respond to note that the reservation has been made. Thus, the system allows communications to be sent in advance of a service.

A service provider can also register with the system as a tippee by first establishing an account with the system. This can be done by registering on-line via a website (as well as a smart phone as mentioned above) hosted by a server for the tipping system, for example. The service provider in most cases will be affiliated with a fixed geographical location. Thus, the service provider can register as associated with a particular business or a particular location. For example, Carol Smith can register as a waitress at Applebee's on Camelback Drive. By associating the service provider with a particular location, the system will be able to assist the consumer in locating a particular service provider when the consumer attempts to look up that service provider's profile.

The service provider can be issued an identifier such as a four-digit identifier that will allow a consumer to easily identify the service provider. In addition, the service provider can be assigned a quick response (QR) code or other bar code. The QR code will allow consumers to capture the QR code on their mobile devices, upload the QR code to the server to identify the profile for the service provider, and send a tip, comment, rating, or communication, for example.

The system can issue a badge to a service provider that allows the service provider to easily communicate his/her ID or QR code to consumers. For example, waitresses could wear a badge or bracelet that a consumer could quickly take a photo of when dining at the waitress' table.

As part of the registration process, the service provider can upload a picture of the service provider that can be used to identify the service provider. In addition, the service provider can upload a name. In one embodiment, a service provider will provide their full legal name for registration and account set up but the smart device, personal computer, and badge will only show the first name or nick name in order to protect their privacy. A service provider might also include a message to be part of their profile. For example, “Thank you for the tip—I'm using the tips that I earn to help pay my college tuition.”

In some instances, the service provider will not be associated with an easily identifiable business name or location on a daily basis. For example, a cab driver who frequently picks up guests from the Sheraton hotel may choose to register his/her profile as being located at the geographical coordinates for the Sheraton hotel. Thus, when the consumer seeks out the cab driver's profile based on current GPS coordinates, the consumer will see the cab driver's profile for selection.

In some instances, a service provider might choose to provide several different locations when their location varies.

The system will be able to identify all service providers in an area proximate to the location of the consumer. So, if the consumer communicates with the server noting his/her current geographical location and the various service providers communicate with the server noting their current geographical locations, the server should be able to easily match up the consumer with potential service providers. In the case of the cab driver, this would be useful because the consumer could apply the tip shortly after departing the cab—even if the consumer was in an unfamiliar city and not familiar with the names of places or cab companies. The server would simply present the consumer with the profiles of cab drivers in close proximity to the consumer's coordinates. This could be used for hailing a cab, a waitress, a bell boy, or other service provider, as well.

In one embodiment, it is envisioned that a service provider could check into the system each day. This would notify the system that the service provider was on duty and available. It would also allow the service provider to provide a current GPS location.

The service providers can obtain a variety of benefits by participating in the system. For example, as noted herein, the service providers can receive feedback and ratings from customers. In addition, the system might be used by the service providers to send messages to their customers. For example, the system might provide a pre-programmed option for the service provider to acknowledge that the tip was received and to thank the consumer. The system might similarly allow the service provider to send a message to the customer upon receipt of the customer's tip or message.

The system can provide the service providers with various ratings. For example, the system could be configured to determine the service providers that received the best ratings for a particular restaurant. This might be used by the management of the restaurant to reward the top service providers by assigning the top waiters/waitresses to wait on the most lucrative seating areas of the restaurant.

The system could also be configured to acknowledge a particular service provider as being rated as one of the highest service providers in a particular region. Thus, a waitress could use such information on a resume to demonstrate to potential employers how well-qualified she is, for example. Moreover, service providers will be able to build a resume based on service ratings.

The system might also be configured to announce the presence of noteworthy customers. For example, a restaurant could designate particular customers as VIP's. When those customers approach the restaurant, their GPS information can be communicated via the server to restaurant management or wait staff. This would alert the restaurant personnel to take steps to provide VIP treatment for the VIP customer. Similarly, the system could be configured to determine that a customer is a returning guest. This could be accomplished in a number of ways. One way would be to track how recently the customer had applied a tip to a person at the geographical location where the service provider is located.

In one embodiment, the system could be configured to allow the service provider to rate a customer. For example, if a tip is received from a customer, the system could prompt the service provider to rate the customer as a good or bad tipper, or as a rude or polite customer, or as an easygoing or high-maintenance customer, as well. Depending on the industry, such ratings might be of use to service providers when a customer returns at a later date. The system could be configured to allow the service provider to enter a note. For example, a waitress could comment: “Mr. Jones really enjoys salmon.” Thus, the waitress could remind Mr. Jones how much he enjoyed the salmon at the restaurant the last time he visited. They could also remind customers of their wine preference and provide all sorts of hints that will improve customer service and could potentially increase service gratuity such as “I know you enjoyed your Chassagne Montrachet 2009, would you like try order the same wine?” or “we have another burgundy wine you might want to try . . . ?”

In addition to individuals, businesses can participate as service providers and sign in as a business account. Thus, a business can be assigned an identifier, GPS location, NFC code and/or a QR code. This can be useful when a consumer wants to communicate directly with management. Such identifiers can be located at the front entries to businesses, on restaurant tables, as part of menus, in the backseats of cabs, etc. This will allow the businesses to obtain a great deal of feedback that the businesses can use to improve service.

One way in which a business can participate is by receiving a rating by a consumer. These ratings can be utilized by the system operator to generate a list of top service providers in a region. For example, the system can be used to generate a list of the top (and best service) hotels in the Scottsdale, Ariz. area based on ratings received from consumers who use the mobile application.

When a business participates as a service provider, the system can be used to communicate directly with management. Thus, if a consumer arrives at a restaurant, for example, a consumer can contact management directly if service is bad or good.

A business may also use the feedback provided by the system to manage staff. Thus, regardless of whether a business participates as a service provider, the business can arrange to receive feedback from the system about staff. In a restaurant, for example, this would be useful to determine whether staff is courteous to customers. It would also be useful to determine which staff members are liked best by customers. Staff members could be rewarded or recognized for providing good service or for receiving nice remarks or high ratings by customers. Similarly, staff could be disciplined for receiving negative remarks or low ratings by customers.

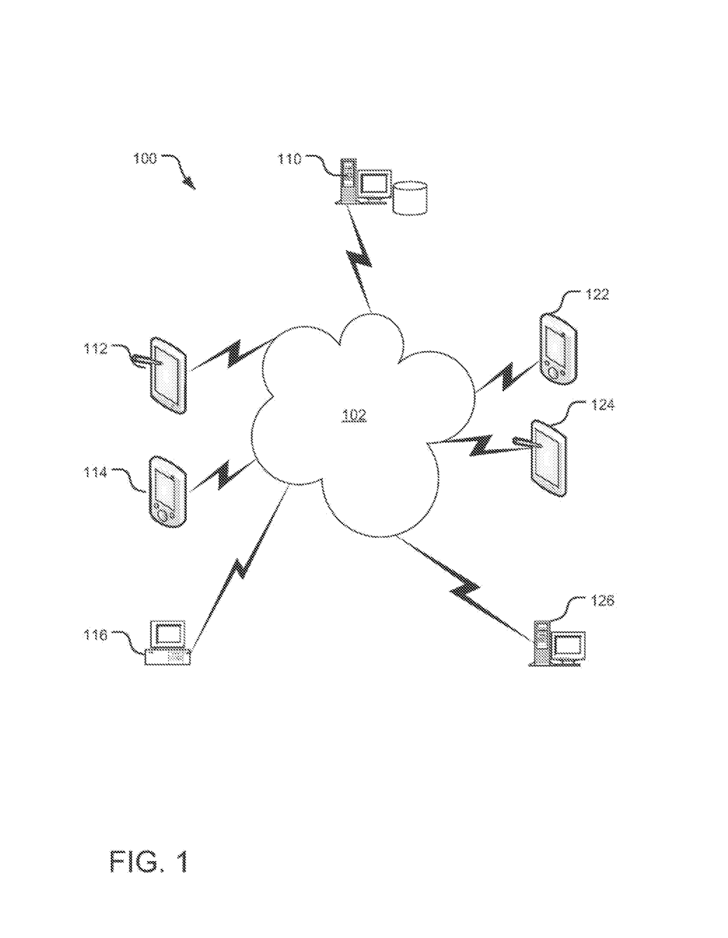

FIG. 1 shows an example of a system for providing tips in accordance with one embodiment. In the example of FIG. 1, a system operator computer 110 is shown coupled with a network 102, such as the internet. Various consumers can register with the system via their different computing devices. FIG. 1 shows a first consumer participating via a tablet computer 112. Another consumer is shown using a mobile phone 114. Yet another consumer is shown using a desktop computer 116.

Service provider devices are also shown in FIG. 1. For example, a first service provider can participate using a mobile phone 122. A second service provider can participate using a tablet computer 124. A third service provider—perhaps a business—is shown participating via a desktop computer.

The tipping system can be operated to provide various data to participants. For example, the tipping system can calculate the total tips for the day or shift received by a service provider. The system could determine the most productive days or times of day (in terms of tips) for a service provider. The system could determine the day's tips, comments, and/or ratings for a service provider.

As described herein the system can identify servers in a geographical area that are participating in the tipping system.

The system can send a notice to a service provider each time that a tip is received. In one embodiment, the system can show the picture of the consumer who applied the tip (e.g., based on the consumer's photo in the consumer's account profile). Also, in one embodiment, the tippee and tipper will have an up-to-date easy access account summary to monitor activity from smart phone and PC access.

The tipping system may be coupled with various financial systems to facilitate payment of the tips. In one embodiment, the system may be coupled to a background “seamless” credit card or debit card account that will facilitate the transaction between parties. This may be created at the time of sign-in as a first time user, either as tipper or tippee. The tipper may provide a credit or debit card account and the tippee will just create an account for mobile payment. A Branded credit/debit card may also be available. The transaction may be a cashless transaction by use of a smart phone with a preset account as described above.

In accordance with an exemplary and non-limiting embodiment, a short, one to two screen introduction to the app may be seen the first time users download and open the app, such as, for example, on a smart phone. The introduction may re-communicate the value proposition of the app and get users directly in to creating an account. In some instances, users may log into the app with an email address as their username. After logging in, the app may “remember” the user and they will not need to log in again unless they log out from the main menu. For ease of signing up, users may be given the option to use their existing Facebook profile to create an account. After logging in, the app may “remember” the user and they will not need to log in again unless they log out from the main menu. The user may be provided a checkbox or other mechanism by which to indicate selection of an “I want to accept tips” option. Depending on what the user selects for the “I want to accept tips” option will determine what other information is required from the user.

In some instances, for added security, users may be given the opportunity to create a multi-digit, such as a 4-digit, personal identification number (PIN). Each time the user opens up the app, they may be prompted to enter their PIN rather than having to login with their email address/password. Users that skip this step may be prompted again to add a PIN at a later date (e.g., after opening the app a predetermined number of times, the user may be alerted to add a PIN.

In some embodiments, a screen may request additional information, such as, for example, an address. Users that don't have a set work address (e.g., valet, landscapers, cab drivers, etc.) may skip the address portion of the screen. To be found by a tipper via GPS, such users may need to “check-in” to work when they start their shift. Uploading a profile photo may help tippers identify whom they want to tip more easily. Tapping a button may give the user the option of taking a photo or choosing one from their library.

In other embodiments, users may be assigned a random 4-character alphanumeric code and a QR code for tippers to use to find them in the app. In some embodiments, tapping a print button may give the users the ability to print their QR code, such as via iOS AirPrint. Users may also be given the option to email the QR Code so they can print it from their desktop or laptop computer.

In some embodiments, it is advantageous for the tippee to “check-in” to work before each shift. This allows tippers to find them via GPS. In the event they forget to check out, they may be automatically checked out of work after a predetermined and configurable length of time, e.g., 12 hours, for security purposes. In some embodiments, tippees may see some basic reporting on their home screen including a total of the day's and the week's tips. A list of the most recent tips may be displayed with the ability to tap a link that will show that day's tips, comments and ratings.

After a set interval of time has elapsed (e.g., 3 days), the tippee may be reminded that they can also use the app as a tipper. An alert may be shown to them again until they enter their payment information or dismiss the alert. In some embodiments, tippees may be able to “dismiss” the alert from showing again by tapping a button on the alert. Push notifications may also be used to alert the tippee to update their account in the event they don't open their app.

After providing their basic profile information, tippers may be asked to either take a picture of, or manually enter, their credit card information. The payment information may be saved so they do not need to enter their information again to give a tip. They may have the ability to edit their payment information from their account settings page. After completing the setup process, users may be given the opportunity to share the app with friends on social media (e.g., Facebook, Twitter, SMS, etc.).

There is now described an exemplary embodiment of the tipping process. If a user has set up a PIN, they may be prompted to enter the 4-digit code each time they open the app. By default, tippers may see a list of “nearby” tippees based, for example, upon a GPS location. If they don't see the person they want to tip they may enter the tippee's 4-character code or scan their QR Code. Once the tipper has found their tippee, they may be presented the option to tip one of the amounts specified by the tippee, or enter a different amount manually. Tippers may select the tip amount, and then tap a “confirm” button to submit the tip. In other embodiments, the tipper may utilize the system to pay for the goods and services provided in addition to leaving a tip.

Once the tip has been processed, the tippee may receive a push notification of the transaction. After the tip has been successfully sent to the tippee, the tipper may receive a confirmation message and the option to “rate” the tippee and leave a short message. At this point, the user may either skip to go back to their home screen or close the app.

There is now described an exemplary embodiment of a user's ability to share screens. Users may have the ability to either tap a tab or swipe between FAQ and Support on their electronic devices. In one embodiment, this may be the same information available on the website. In other embodiments, users may have the ability to either tap a tab or swipe between Privacy and Terms. Once again, this may be the same information available on the website.

There is now described various exemplary embodiments of features that may be enabled via an app. In some embodiments, an introduction may re-communicate the value proposition of the app and will get users directly into creating an account.

In other embodiments, a login feature may allow users to log into the app with either an email address as their username, unique username, fingerprint, “Branded ID code” or personal ID. After logging in, the app may provide an option to store user credentials until the user logs out from the main menu. There may further be provided an option to create a “branded passkey” for safe fast access to the account and skipping entry of an account number or password.

In some embodiments, users may be given the option to use their existing Facebook profile to create an account. After logging in, the app may store user credentials until the user logs out from the main menu. What the user selects for the “I want to accept tips” question will determine what other information is needed from the user.

In some embodiments, a create PIN may be included. For added security, users may be given the opportunity to create a 4-digit PIN (“branded passkey”). Each time the user opens the app, they will be prompted to enter their PIN rather than having to login with their email address/password. Users that skip the branded passkey creation step may be prompted again to add a PIN at a later date (e.g., after opening the app X times an alert will be generated to add a PIN).

In other embodiments, a feature may enable information gathered to identify user. A tippee user may have to provide personal information including residential address and a SSN to create a mobile payment account. They may be given the option to provide a work address to be identified via GPS. Users that don't have a set work address (e.g., valet, landscapers, cab drivers, etc.) can skip the address portion of the form. To be found by a tipper via GPS, they'll need to “check-in” to work when they start their shift.

Uploading a profile photo may help tippers identify whom they want to tip more easily. Tapping a button may give the user the option of taking a photo or choosing one from their library.

In other embodiments, a feature may enable the selection of a Tip Array. Users may select a pre-defined “tip array” (for example, $5, $10, $20 or create their own custom amounts). These values may be presented to tippers along with an “other” option during the tipping process.

In other embodiments, a feature may enable tip sharing. A tippee may be able to choose whether they want to share the tip with coworkers by clicking a tab to arrange a tip sharing option. Then, coworkers can be selected from the list of users and get their predetermined tip % from the total tip.

In other embodiments, an account setup confirmation feature may be enabled. Users may be assigned a random 4-character alphanumeric code (Branded ID Code) and a QR Code (for tippers to use to find them in the app). Tapping a print button may give the users the ability to print their QR code, for example, via iOS AirPrint. Users may also be given the option to email the QR Code so they can print it from their desktop or laptop computer. ID tags may be sent to a tippee with logo, QR code and name.

In some embodiments, the attendants should “check-in” to work before each shift. This will allow tippers to find them via GPS. Attendants that fail to check out after 12 hours may be logged out automatically. The attendants may see some basic reporting on their home screen including a total of the day's and the week's tips. A list of the most recent tips may be displayed with the ability to tap a link that will show that day's tips, comments and ratings. Attendants can also identify the most productive days and times to work. In some embodiments, data related to the system may be stored in a repository for access by various entities including, but not limited to, consumers, service providers and the like. Such data may be mined by the system to provide periodic reporting of data analytics to an entity.

In other embodiments, there may be presented a feature for performing server identification. In such instance, the app may identify servers in the area accepting tips via the app. By incorporating QR code, alphanumeric ID, picture ID and GPS locator, the app may identify servers in the area and may also incorporate long and short range Bluetooth, Near Field Communication and iBecom technology to ID participants.

In other embodiments, a feature may allow attendant users to receive an option to convert into tippers. For example, after a set interval of time has elapsed (e.g., 3 days), the app may remind the attendants/users that they can also use the app as a tipper or tippee. The alert may be shown to them until they enter their payment information or dismiss the alert. Users may be able to “dismiss” the alert from showing again by tapping a button on the alert. Push notifications may also be used to alert the tippee to update their account in the event they don't open their app often.

In yet another embodiment, a feature allows tippers to setup an account. After providing their basic profile information, tippers may be asked to either take a picture of or manually enter their credit card information. The tipper's payment information may be saved so they do not need to enter their information again to give a tip. The tipper may have the ability to edit their payment information from their account settings page.

After completing the setup process, users will receive confirmation and be given the opportunity to share the app with friends on social media (e.g.: Facebook, Twitter, Instagram, SMS, etc.)

If a user has set up a PIN, they may be prompted to enter the 4-digit code each time they open the app. By default, tippers may see a list of nearby servers based upon GPS location. If they don't see the person they want to tip they can enter the tippee's 4-character code or scan their QR Code or use Near Field Communication technology. Other embodiments may incorporate iBecom technology.

Once the tipper has found their attendant, they may be presented the option to tip one of the amounts specified by the server, or enter a different amount manually. Tippers may select the tip amount, and then tap the “confirm” button to submit the tip. Once the tip has been processed, the server may receive a push notification of the transaction. After the tip has been successfully sent to the server, the tipper may receive a confirmation message and the option to “rate” the tippee and leave a short message. At this point, the user can either skip to go back to their home screen or close the app.

In other embodiments, users may be able to edit their profile. In yet other embodiments, users may have the ability to either tap a tab or swipe between FAQ and Support.

In accordance with other embodiments, users may have the ability to either tap a tab or swipe between Privacy and Terms.

Other embodiments may enable social network integration for servers to connect and exchange information on job opportunities across areas, post their resumes or for employers to post job openings to attract top servers, etc.

In yet other embodiments, there may be provided advertising platform integration for companies promoting their services and products for tippers.

In other embodiments, there may be provided instant message/feedback. In such instances, the app may provide a platform for tippers to send messages to companies about their service or to make special requests ahead of arrival. A tipper may communicate with his favorite concierge ahead of a trip to make special arrangements, send a message to the server or make reservations through the social network.

Partnered companies may receive instant feedback from customers having a negative experience; for example: a customer sends a message to the manager of the establishment that has registered with for instant feedback to let them know that “I have been sitting here for over half an hour and nobody has approached me for service”, etc.

In other embodiments, users that do not want to register their bank accounts may have the option to use branded Debit cards to upload their tips. Debit card users may have the ability pay with these cards at any establishments accepting debit cards or make withdrawals at participating ATMs. A “pay with Debit Card” option by using the smart phone (digital payment) in addition to the debit card.

Other embodiments may incorporate a feature to issue alerts about customers. The data collected in such an app may allow servers and management to identify VIP Customers, poorly-rated tippers, or any significant incident reported by other users via popup alerts. The application may capture, track and retrieve the date of each tipper to generate instant messages for servers.

In other embodiments, the application may implement a five-star server-rating system with data generated by tippers. This may generate a “top performers” type of list; such as top 100 servers lists per geographical area and top servers lists per industry. Once the tipper rates the level of service received from attendant, this data may be stored and compiled and then analyzed to generate top performers lists that will be published to a webpage. The application host may generate a monthly report with baseline and then monthly progress of service rating and they can also compare this with their closest competitors or benchmark against a particular industry. The application may compile data to help users understand the tipping practices per region, for example: who to tip and how much is customary in Spain vs. USA?

The tipping system may be used as a social network. For example, service providers, such as waitresses, may be able to connect with one another to share information. In addition, the system could be used to notify service providers of job opportunities. Likewise, the system could be utilized to allow service providers to post resumes and for employers to post available positions,

In one embodiment, the system could be used to gather data about particular service providers in a region. Lists of top service providers in an industry could be sold to businesses so that the businesses could recruit such top talent.

Moreover, waitresses/waiters, for example, could use their verified ratings/comments on their resume.

Various businesses could use their high ratings to attract employees. For example, a restaurant could show potential waiters/waitresses average tips or ratings that the wait staff has earned historically at a particular restaurant. Similarly, such ratings could be used to advertise the business by publishing how well-rated the service providers are.

Moreover, the system could publish lists of the top service providers for a particular industry/region. Such ratings could be used by service providers to bolster their resumes.

One of the challenges of tipping is that consumers often do not know the appropriate amount to tip. As a result, consumers often do not tip or do not tip appropriately—which is the worst situation for a service provider. In accordance with one embodiment, an informational module can be provided that allows the user to query what is the tipping custom for an industry, city or region of the world. For example, tipping is less common in the Europe as compared to the United States. Thus, a consumer could query the application, select an industry, select a country (or allow the GPS determining feature to identify the country) and be given a brief explanation as to whether tipping is appropriate.

The application could also be configured with a currency converter to show a traveler what the equivalent tip would be in the traveler's home currency.

In one embodiment, a device could even be used to perform ancillary features associated with tipping. For example, since tipping is frequently implemented in restaurants, one ancillary feature that could be implemented is a bill dividing feature. In such an embodiment, a user could enter the total amount for a meal; enter the number of payors; and receive a report as to how much each payor should pay and the appropriate tip, as well.

In another embodiment, the system could be configured to receive a report as to what was on the bill and how much each item cost. A user could then divide up the bill based on the food items each payor was responsible for. This is often a problem when a group of business colleagues go out to lunch or dinner and want to split the bill.

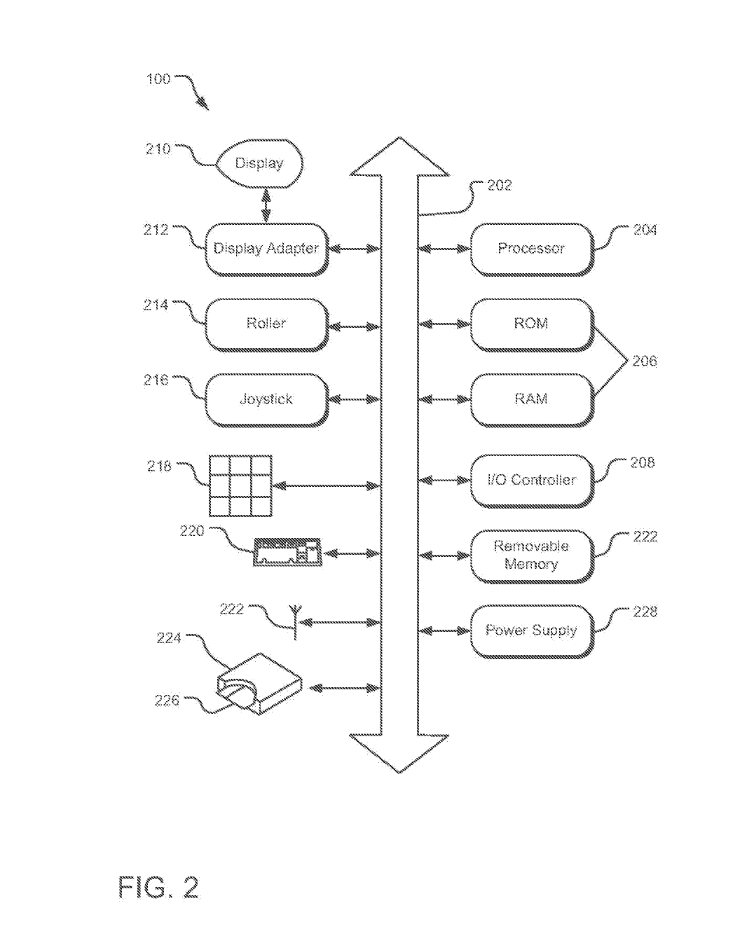

FIG. 2 discloses a block diagram of a computer system 200 suitable for implementing aspects of at least one embodiment. As shown in FIG. 2, system 200 includes a bus 202 which interconnects major subsystems such as a processor 204, internal memory 206 (such as a RAM or ROM), an input/output (I/O) controller 208, removable memory (such as a memory card) 222, an external device such as a display screen 210 via a display adapter 212, a roller-type input device 214, a joystick 216, a numeric keyboard 218, an alphanumeric keyboard 220, smart card acceptance device 224, a wireless interface 226, and a power supply 228. Many other devices can be connected. Wireless interface 226 together with a wired network interface (not shown), may be used to interface to a local or wide area network (such as the Internet) using any network interface system known to those skilled in the art.

Many other devices or subsystems (not shown) may be connected in a similar manner. For example, a module that facilitates voice activated commands may be implemented. Also, it is not necessary for all of the devices shown in FIG. 2 to be present to practice an embodiment. Furthermore, the devices and subsystems may be interconnected in different ways from that shown in FIG. 2. Code to implement one embodiment may be operably disposed in the internal memory 206 or stored on storage media such as the removable memory 222, a floppy disk, a thumb drive, a CompactFlash® storage device, a DVD-R (“Digital Versatile Disc” or “Digital Video Disc” recordable), a DVD-ROM (“Digital Versatile Disc” or “Digital Video Disc” read-only memory), a CD-R (Compact Disc-Recordable), or a CD-ROM (Compact Disc read-only memory). For example, in an embodiment of the computer system 200, code for implementing the a remote tipping application may be stored in the internal memory 206 and configured to be operated by the processor 204. Devices can also communicate by NFC, blue tooth technology, beacon and beam technology (android)

Currently, tipping service workers and other professionals can be a cumbersome and confusing experience for both the tippers and the individuals receiving the tip. The systems and methods disclosed herein may comprise a tip pool in order to manage tipping and provide an integrated device-based solution to the problems currently involved with tipping. The tip pool may be used by many different types of individuals including, but not limited to, service professionals. The tip pool may enable a service professional to split or share the gratuity generated for the service with coworkers by percentage or specific amount, either manually or automatically. Additionally, the tip pool may enable an option which allows service professionals to select whether to allow the sharing of gratuity amongst members of the team.

In embodiments, service professionals participating in a tip pool may decide to appoint a single individual's account as the manager account. The money received for the tip pool may be deposited into the manager account and the individual associated with the manager account may then determine how to split the money received at the end of the shift among several other shift participants. In such embodiments, the manager account may be permanent or may be changed for predetermined periods of time, such as on a per shift basis, a per week basis, and the like. In embodiments, service professionals may decide to use a separate group tip pool tool account to be designated as the manager account for a predetermined period of time, such as, but not limited to, on a shift by shift basis. In such embodiments, service professionals may choose to redirect funds they individually receive for tips during a defined shift before the shift starts. At the end of the shift, the money may be either manually or automatically redistributed to all service professionals pool participants for that shift. In embodiments, the manager account may be a coworker's account, an employer's account, or a third party's account. For employers, the tip pool may provide information such as detailed information about gratuities per hour, shift, day, week, month, and various other metrics with the amount to be distributed to employees. Such information may be used for compliance and payroll purposes. The tip pool may be interfaced with existing payroll programs.

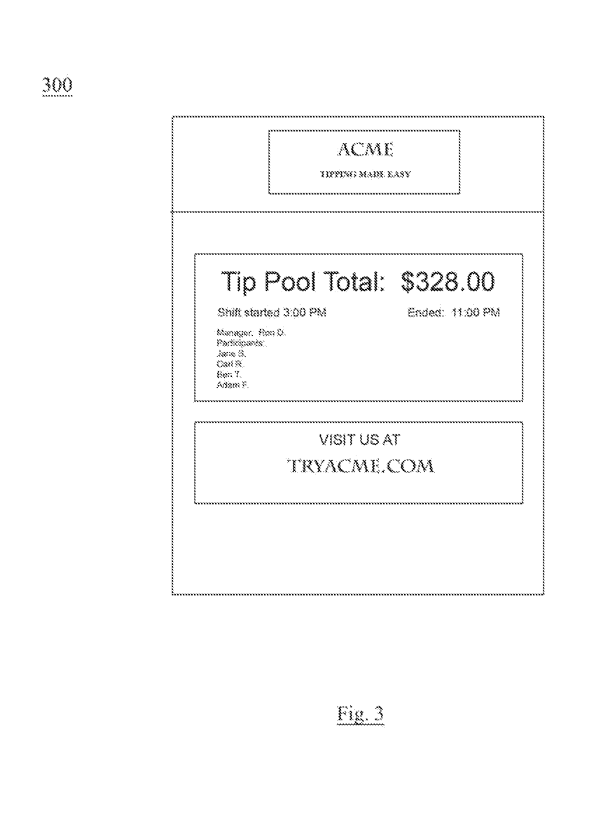

In embodiments and in FIG. 3, each service pool participant may receive at the end of each shift an email with the tips collected during that tip pool shift and the names of participants so that the service participants may can track how much belongs to each depending on the internal rules they have for tip pool redistribution 300. The term shift as used herein includes, but is not limited to, a defined work shift for a worker receiving tips (e.g., waiting tables during the dinner shift), a shift represented by an event during which employees and potential tippees may or may not have overlapping work periods (e.g., a wedding reception), a shift represented by a start time and an end time during which a potential tippee participated for the full duration or time or a partial duration within the defined shift, or some other type of shift or any other duration of time. In another example, a shift as used herein may refer to a period of worker performance, including salaried worker performance, during which an employee, consultant, or some other third party may perform an activity that merits a tip distribution or other payment. For example, a group may be working on a product launch. This group may include salaried workers, part time workers, consultants, contractors, hourly employees, freelance third parties, or some other type of worker. Continuing the example, the work period, or shift, leading up to the product launch may be a 6-month period. Each worker in the group may work differing amounts of time, during different periods of time falling within the shift. In this example, the shift may close at the point of the product launch, and after a period of sales, for example, the workers in the group may be rewarded, tipped or paid a bonus according to the methods and systems described herein.

In embodiments, the tip pool may be deployed using a tip pool application. The tip pool application may be configured to interact with a mobile device, such as, but not limited to, a smart phone. The tip pool application may comprise a tipper-facing application component, as well as a service professional-facing application component. The tipper-facing application component may allow a tipper to enter in personal information as well as payment information, such as, but not limited to, a bank account or credit card number. The service professional-facing application component may allow a service professional to provide identifying information so as to receive payments, as well as financial information, such as a bank account. Both application components may comprise a user interface so that the service professional or the tipper may interact with the application.

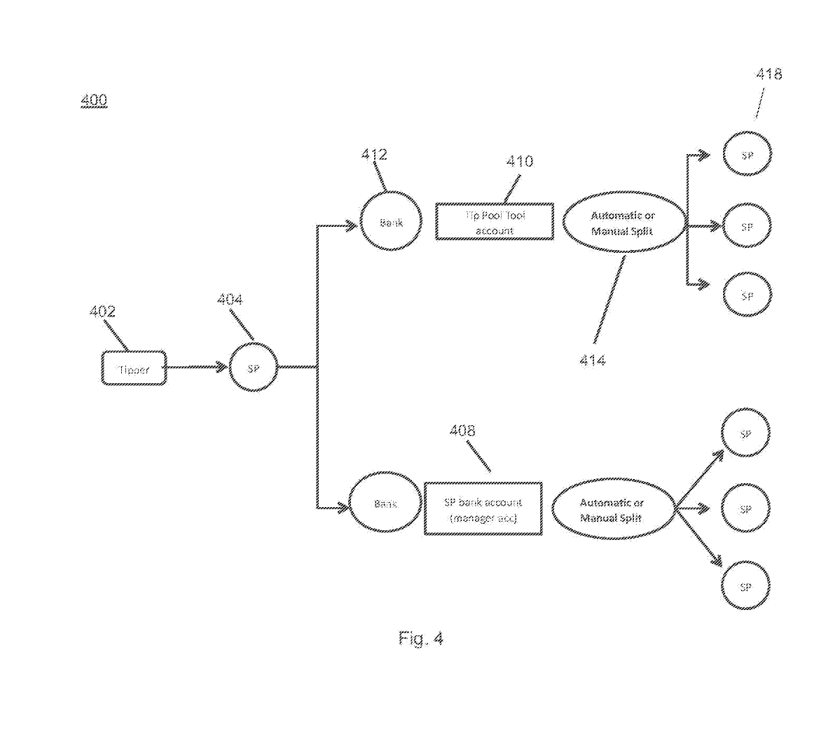

In embodiments and in FIG. 4, each service participant may first register for a particular pool shift by indicating via an in-application toggle, that the service participant will be participating in a tip pool. The service participant 404 may then select the account that will act as the manager account, such as one of the other participants 408 or the group tip pool tool account 410. Individuals may also select the start time and end time for a particular pool shift. A tipper 402, using a tip pool enabled mobile device and the tipper-facing interface, may then identify the tipper's service professional and give a tip via the application. The tip pool application may then draw money from the tipper's account 412 and direct the funds to the identified manager account selected by the tip pool participants. The manager account may then start accumulating tips from all service professionals participating in the pool. At the end of the shift, all participants may receive an automatic email with the receipt comprising information such as the time of the shift start and end of the shift, as well as the names of the participants and the total amount collected during the shift. The manager account may manually or automatically split 414 the funds among participants based on the internal pool sharing arrangement determined by the service professional participants and the total amount collected during the shift, distributing the funds automatically or manually to the participating service professionals 418. The automatic redistribution may be done via email, text message, or a background preprogrammed tool integrated to the manager account in order to distribute funds, among other methods known to the art.

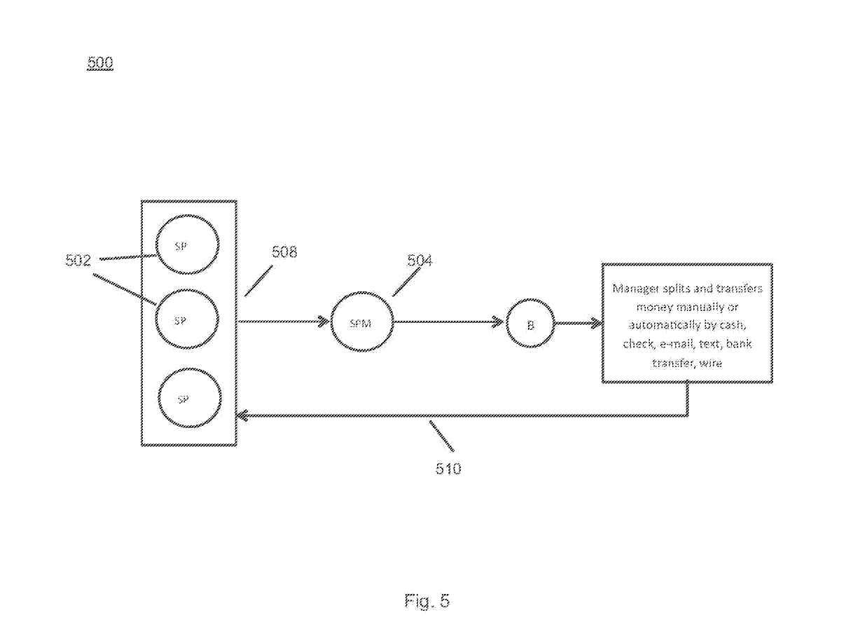

In embodiments and in FIG. 5, the tip pool application may split the tip prior to processing by the manager account. In such embodiments, service providers 502 may register for a particular pool shift and designate an account that will be the manager account 504 and an individual that will act as manager account manager. A tipper may identify his or her service professional and give a tip via the tip pool application. The tip pool application may then draw money from the tipper's account, split the tip according to the predetermined splitting agreement, and then direct the funds to the identified manager account selected by the tip pool participants 508. The manager account may then start accumulating tips from all service professionals participating in the pool. At the end of the shift, all participants may receive an automatic email with the receipt comprising information such as the time of the shift start and end of the shift, as well as the names of the participants and the total amount collected during the shift. The manager account may manually or automatically distribute the funds 510. The automatic redistribution may be done via email, text message, or a background preprogrammed tool integrated to the manager account in order to distribute funds, among other methods known to the art. Additionally, the manager account manager may manually distribute the funds by cash, check, e-mail, text, bank transfer, or wire, among other methods.

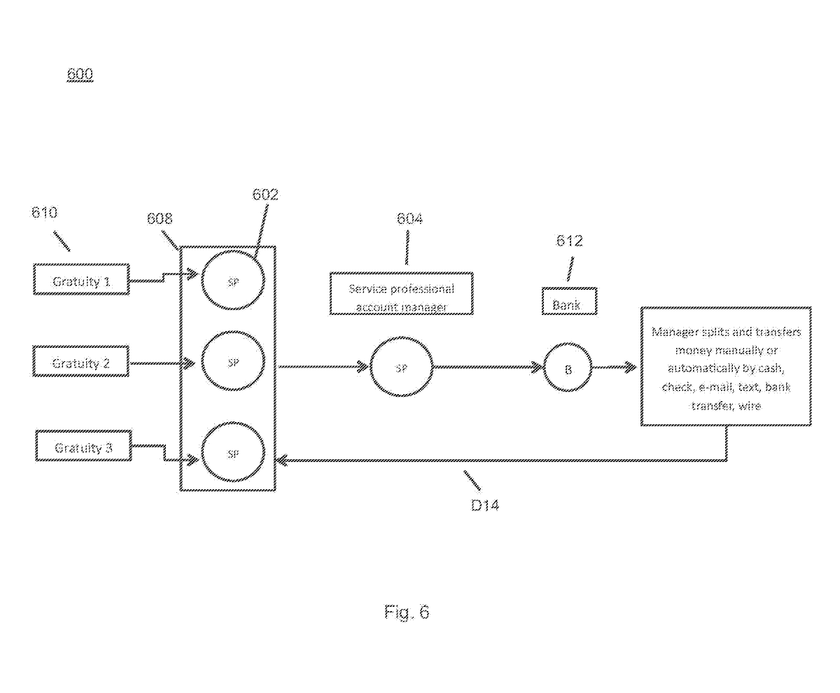

In embodiments and in FIG. 6, the service provider may select between an individual or shared account for each instance of gratuity. In such embodiments, service providers 602 may register for a particular pool shift and designate an account that will be the manager account 604 and an individual that will act as manager account manager. A tipper may identify his or her service professional and give a tip via the tip pool application 610. The service professional may then select between a single user and sharing account via a toggle provided by the service provider-facing application component and interface 608. The tip pool application may then draw money from the tipper's account 612 and direct the funds to the designated account. If the service professional selects a single user, the tip pool application may deposit funds into the individual's private account. Likewise, if the service professional selects the manager account, the funds may be deposited in the manager account. The manager account may then start accumulating tips from all service professionals participating in the pool. At the end of the shift, all participants may receive an automatic email with the receipt comprising information such as the time of the shift start and end of the shift, as well as the names of the participants and the total amount collected during the shift. The manager account may manually or automatically split the funds among participants based on the internal pool sharing arrangement determined by the service professional participants and the total amount collected during the shift, subsequently distributing the funds automatically or manually 614. The automatic redistribution may be done via email, text message, or a background preprogrammed tool integrated to the manager account in order to distribute funds, among other methods known to the art. Additionally, the manager account manager may manually distribute the funds by cash, check, e-mail, text, electronic transfer, bank transfer, or wire, among other methods.

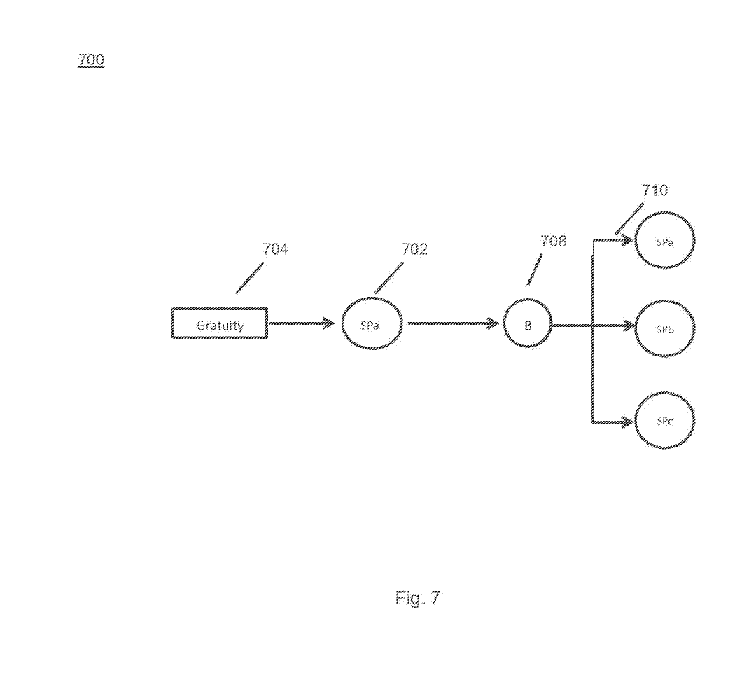

In embodiments and in FIG. 7, the tip pool may not require a manager account. In such embodiments, service providers 702 may register for a particular pool shift. A tipper may identify his or her service professional and give a tip via the tip pool application 704. The tip pool application may then draw money from the tipper's account 708 and directly split the funds according to the gratuity sharing agreement 710. The funds may then be directly transferred to each participating service professional via email, text message, or a background preprogrammed tool integrated to the manager account in order to distribute funds, among other methods known to the art. At the end of the shift, all participants may receive an automatic email with the receipt comprising information such as the time of the shift start and end of the shift, as well as the names of the participants and the total amount collected during the shift.

In embodiments, the tip pool option may allow gratuity to be split right after receiving the tip from the tipper. The gratuity may be split for the service provider before it is processed by the merchant processor. The money may then be split as determined by participants and deposited in the participant's account. At the end of the shift, all participants may receive an automatic email with the receipt comprising information such as the time of the shift start and end of the shift, as well as the names of the participants and the total amount collected during the shift. The manager account may manually or automatically split the funds among participants based on the internal pool sharing arrangement determined by the service professional participants and the total amount collected during the shift, subsequently distributing the funds automatically or manually. The automatic redistribution may be done via email or text message or a background preprogrammed tool integrated to the manager account in order to distribute funds, among other methods known to the art. Additionally, the manager account manager may manually distribute the funds by cash, check, e-mail, text, electronic transfer, bank transfer, or wire, among other methods. In embodiments, a tipper and/or tippee may utilize the methods and systems described herein on a mobile device, such as a smart phone, tablet, cellular phone, laptop, or some other type of mobile device. For example, funds may be transferred and managed using a mobile device operating over a distributed network, such as the Internet, Intranet, telecommunications network, cloud computing environment, or some other type of distributed network. Updates, notifications, alerts and the like pertaining to the transfer of tips may be communicated over such distributed networks and presented to a user on a mobile device.

In embodiments, the tip pool may comprise a merchant service solution. The solution may allow businesses to register with the tip pool and receive payments via location determined by GPS, short range Bluetooth, business QR code, Near Field Communications, or tip pool ID codes. Such a solution may enable an environment where there is no need for card swiping equipment. Businesses may receive money from transactions by setting up accounts online or by smart device. The tip pool may comprising processing software with options for detailed web based or smart device transaction execution where the merchant charges the amount and sends it to smart device which either accept or declines the transaction. The tip pool may also comprise QR scanning technology from a merchant computer terminal. The QR code may display at the merchant terminal screen and not on the smart device. This QR code may include details of service or merchandise and total amount. The smart device may scan the merchant QR code and accept or not the transaction. Then, the charge may be paid. Additionally, the tip pool may “ping” the merchant by GPS, NFC, Bluetooth, address registry, tip pool ID code or QR code. The customer may choose the amount charged on the smart device and pay the account. The tip pool may provide detailed transaction reports to businesses and provide continuous user online accessibility.

In embodiments of the present disclosure, the merchant service solution may allow businesses to register and receive payments via a location determined by GPS, short range Bluetooth, business QR code, Near Field Communications, ID codes, or some other type of location identifier. Such a solution may enable an environment where there is no need for card swiping equipment, readers or scanners other than the smart device. Businesses may receive payments from transactions by setting up accounts online or by smart device, including but not limited to a smart phone or tablet computer. In embodiments, the merchant service may connect customers and merchants with software and hardware technology using smart devices. A transaction may be a customer to merchant payment of a specific amount or by the merchant sending the total amount to the customer's device, which then can accept and pay or decline the transaction. This will come in form of push or pull notification or any other similar technology to accept or decline the charge or payment. The same technology will be used to “pay ahead” for telephone orders, pre-ordered items (or service) or take out. The merchant terminal or smart device will be capable of sending a notification to the smart device with total amount and accept or reject payment. This will allow for payment before service is provided or merchandise picked up.

In embodiments, the merchant service may comprise processing software with options for detailed web based or smart device transaction execution where a merchant charges an amount (e.g., to a customer) and sends it to a smart device (push or pull notification) which either accept or declines the transaction. The merchant service technology may also comprise QR code scanning technology from a merchant computer terminal, smart device, or other platform capable of displaying a QR code. As distinguished from current technologies that allow a QR code from a paying smart device (customer) to be copied, hacked and scanned multiple times, QR code processing as used by the merchant service solution, as described herein, may display a QR code at the merchant terminal screen and not on the customer smart device. This QR code may include details of a service, or merchandise and total amount associated with the purchased service or merchandise. The smart device may scan the merchant QR code and accept or reject the transaction. If accepted, the charge may be paid. Additionally, the merchant service solution may “ping” the merchant by GPS, NFC, Bluetooth, address registry, ID code, QR code, or some other means. The customer may choose the amount charged on the smart device and pay the account physically or by some other means. The merchant services solution may provide detailed transaction receipt and reports to customer and businesses and provide continuous user online accessibility.

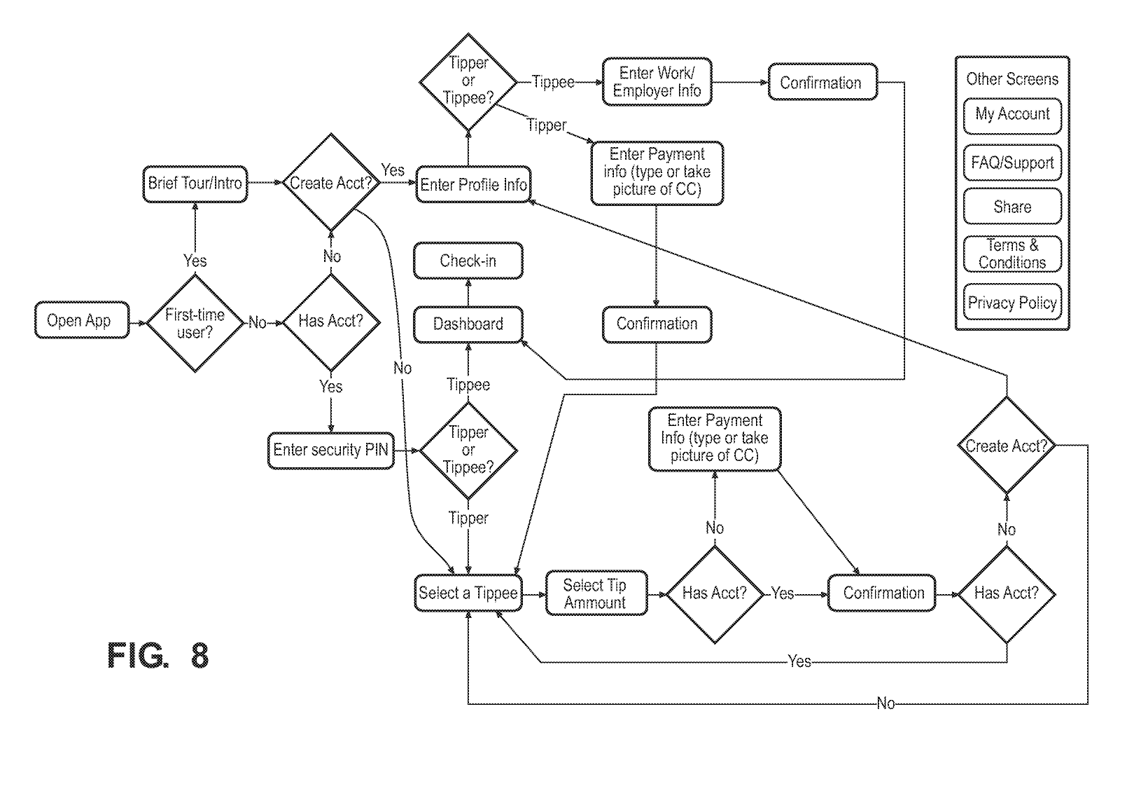

With reference to FIG. 8, there is illustrated an exemplary and non-limiting embodiment of a method for adding a new account via a tipping application.

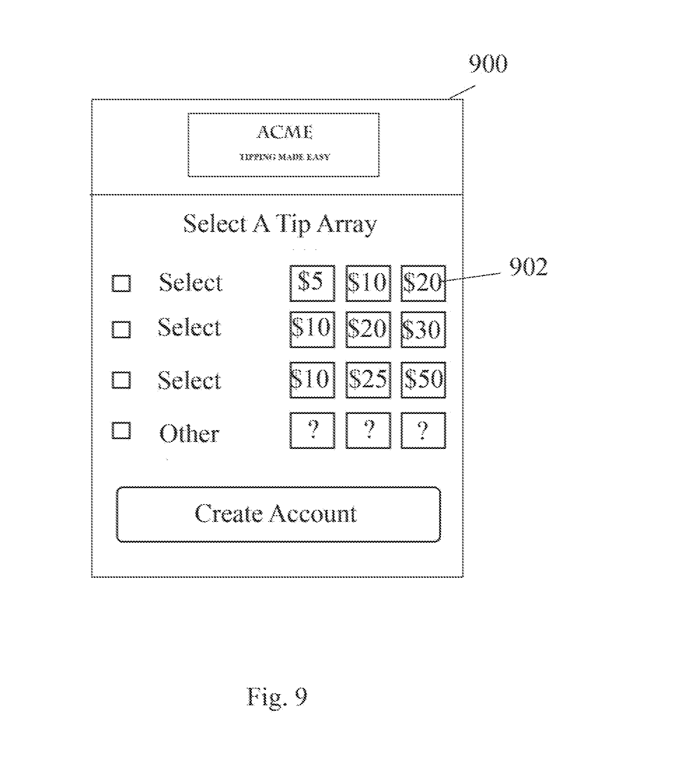

With reference to FIG. 9, there is illustrated an exemplary screen of a smartphone 900 from which a user may select a tip array. Users may select a pre-defined “tip array” 902 or create their own custom amounts. These values may be presented to tippers along with an “other” option during the tipping process.

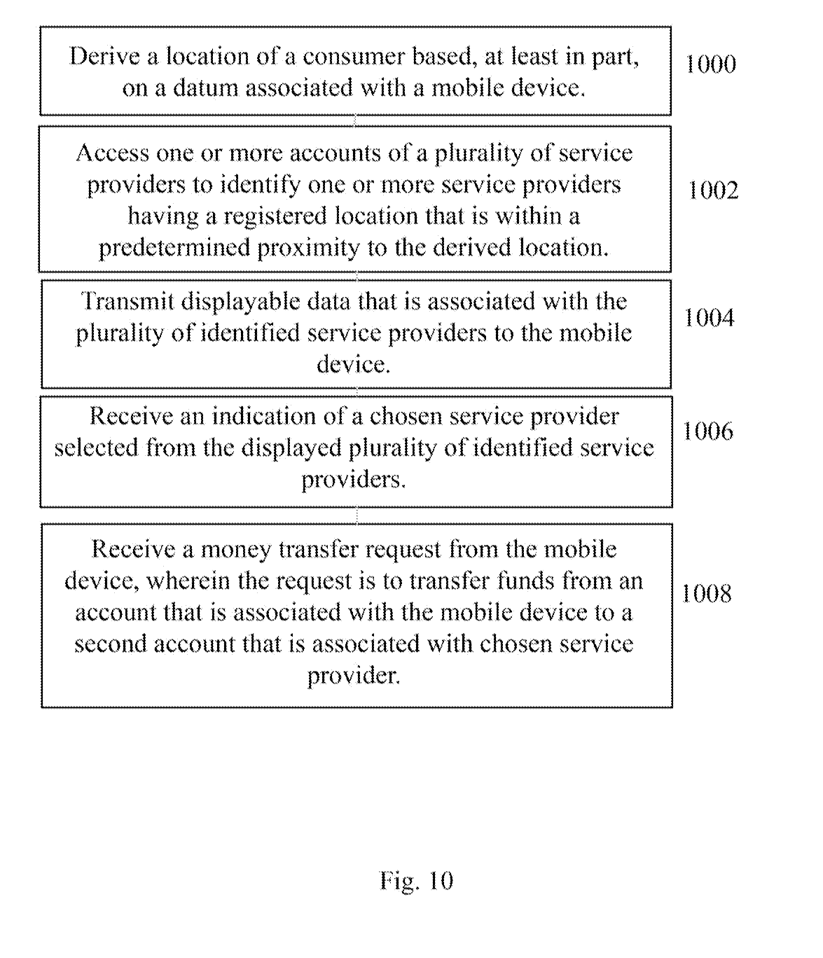

With reference to FIG. 10, there is illustrated a method in accordance with an exemplary and non-limiting embodiment. First, at step 1000, there is derived a location of a consumer based, at least in part, on a datum associated with a mobile device. Next, at step 1002, one or more accounts of a plurality of service providers are accessed to identify one or more service providers having a registered location that is within a predetermined proximity to the derived location. Next, at step 1004, displayable data is transmitted that is associated with the plurality of identified service providers to the mobile device. At step 1006, an indication of a chosen service provider selected from the displayed plurality of identified service providers is received. At step 1008, a money transfer request is received from the mobile device, wherein the request is to transfer funds from an account that is associated with the mobile device to a second account that is associated with chosen service provider. At step 1010, the funds are transferred into the second account.

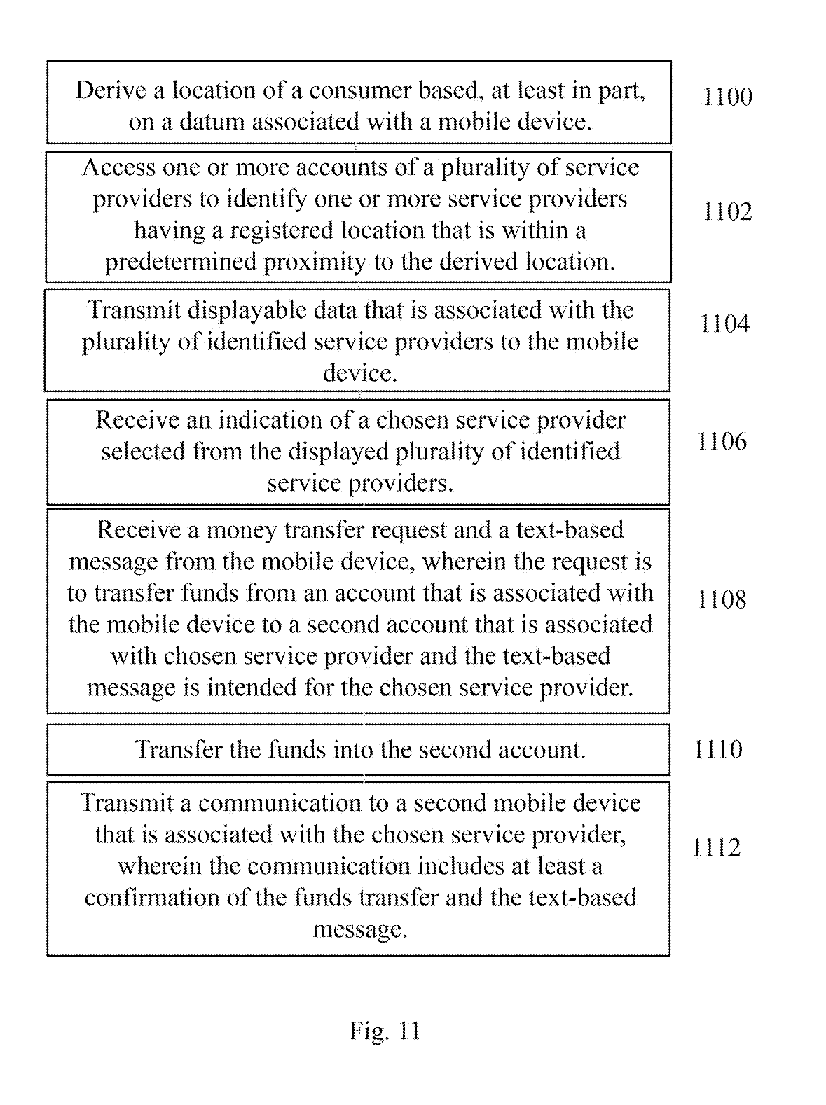

With reference to FIG. 11, there is illustrated a method in accordance with an exemplary and non-limiting embodiment. First, at step 1100, there is derived a location of a consumer based, at least in part, on a datum associated with a mobile device. At step 1102, one or more accounts of a plurality of service providers are accessed to identify one or more service providers having a registered location that is within a predetermined proximity to the derived location. At step 1104, displayable data is transmitted that is associated with the plurality of identified service providers to the mobile device. At step 1106, an indication of a chosen service provider selected from the displayed plurality of identified service providers is received. At step 1108, a money transfer request and a text-based message from the mobile device are received, wherein the request is to transfer funds from an account that is associated with the mobile device to a second account that is associated with chosen service provider and the text-based message is intended for the chosen service provider. At step 1110, the funds are transferred into the second account. At step 1112, a communication is transmitted to a second mobile device that is associated with the chosen service provider, wherein the communication includes at least a confirmation of the funds transfer and the text-based message.

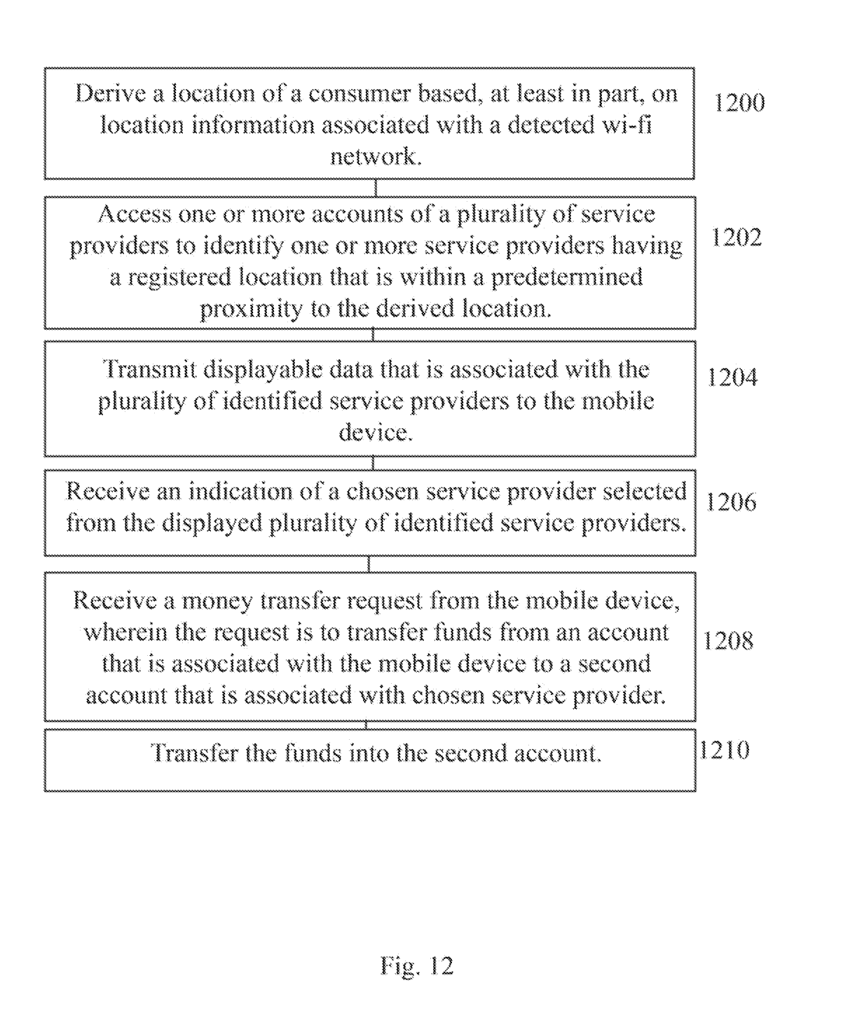

With reference to FIG. 12, there is illustrated a method in accordance with an exemplary and non-limiting embodiment. At step 1200, a location of a consumer is derived based, at least in part, on location information associated with a detected wi-fi network. At step 1202, one or more accounts of a plurality of service providers are accessed to identify one or more service providers having a registered location that is within a predetermined proximity to the derived location. At step 1204, displayable data is transmitted that is associated with the plurality of identified service providers to the mobile device. At step 1206, there is received an indication of a chosen service provider selected from the displayed plurality of identified service providers. At step 1208, a money transfer request is received from the mobile device, wherein the request is to transfer funds from an account that is associated with the mobile device to a second account that is associated with chosen service provider. At step 1210 the funds are transferred into the second account.

In the above description, for the purposes of explanation, numerous specific details are set forth in order to provide a thorough understanding of the embodiments described. It will be apparent, however, to one skilled in the art that these embodiments may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential, as other embodiments may omit such features.

In the interest of clarity, not all of the routine functions of the embodiments described herein are shown and described. It will, of course, be appreciated that in the development of any such actual embodiment, numerous implementation-specific decisions must be made in order to achieve the developer's specific goals, such as compliance with application—and business-related constraints, and that those specific goals will vary from one embodiment to another and from one developer to another.

According to one embodiment, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment, the components, processes and/or data structures may be implemented using machine language, assembler, PHP, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows 8 (or other Windows versions), Windows 7, Windows Vista™, Windows NT®, Windows XP PRO, and Windows® 2000, available from Microsoft Corporation of Redmond, Wash., Apple OS X-based systems, available from Apple Inc. of Cupertino, Calif., Android, Blackberry, or other technology smart phone OS, or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The above specification, examples, and data together with the attached Exhibits provide a complete description of the structure and use of exemplary embodiments of the invention. The attached Exhibit 1 and Exhibit 2 should be considered to form part of this specification. Furthermore, structural features of the different implementations may be combined in yet another implementation without departing from the recited claims.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference.

What is claimed is:

1. A method comprising:
deriving a location of a consumer based, at least in part, on a datum associated with a mobile device;
accessing one or more accounts of a plurality of service providers to identify one or more service providers having a registered location that is within a predetermined proximity to the derived location;
transmitting displayable data that is associated with the plurality of identified service providers to the mobile device;
receiving an indication of a chosen service provider selected from the displayed plurality of identified service providers;
receiving a money transfer request from the mobile device, wherein the request is to transfer funds from an account that is associated with the mobile device to a second account that is associated with chosen service provider; and
transferring the funds into the second account.

2. The method of claim 1 wherein the datum associated with a mobile device is a GPS datum.

3. The method of claim 1 wherein the datum associated with a mobile device is derived via cell phone triangulation.

4. The method of claim 1 wherein the datum associated with a mobile device is derived from location information associated with a detected wi-fi network.

5. The method of claim 1 wherein the registered location is static.

6. The method of claim 1 wherein the registered location is dynamic.

7. The method of claim 6 wherein the registered location is updated periodically by the service provider.

8. The method of claim 1 wherein the displayed plurality of service providers is filtered by occupation.

9. A method comprising:
deriving a location of a consumer based, at least in part, on a datum associated with a mobile device;
accessing one or more accounts of a plurality of service providers to identify one or more service providers having a registered location that is within a predetermined proximity to the derived location;
transmitting displayable data that is associated with the plurality of identified service providers to the mobile device;
receiving an indication of a chosen service provider selected from the displayed plurality of identified service providers;
receiving a money transfer request and a text-based message from the mobile device, wherein the request is to transfer funds from an account that is associated with the mobile device to a second account that is associated with chosen service provider and the text-based message is intended for the chosen service provider;
transferring the funds into the second account; and
transmitting a communication to a second mobile device that is associated with the chosen service provider, wherein the communication includes at least a confirmation of the funds transfer and the text-based message.

10. The method of claim 9 wherein the registered location is static.

11. The method of claim 9 wherein the displayed plurality of service providers is filtered by industry.

12. The method of claim 9 wherein the communication comprises feedback.

13. The method of claim 9 wherein the feedback is associated with a service provided by the chosen service provider in proximity to the registered location of the chosen service provider.

14. A method comprising:
deriving a location of a consumer based, at least in part, on location information associated with a detected wi-fi network;
accessing one or more accounts of a plurality of service providers to identify one or more service providers having a registered location that is within a predetermined proximity to the derived location;
transmitting displayable data that is associated with the plurality of identified service providers to the mobile device;
receiving an indication of a chosen service provider selected from the displayed plurality of identified service providers;
receiving a money transfer request from the mobile device, wherein the request is to transfer funds from an account that is associated with the mobile device to a second account that is associated with chosen service provider; and
transferring the funds into the second account.

15. The method of claim 14 wherein the registered location is static.

16. The method of claim 14 wherein the registered location is dynamic.

17. The method of claim 16 wherein the registered location is updated periodically by the service provider.

18. The method of claim 14 wherein the displayable data is filtered by occupation.
